(19) United States
(12) Patent Application Publication
(10) Pub. No.: US 2022/0335139 A1
(43) Pub. Date: Oct. 20, 2022

(54) METHOD AND APPARATUS FOR IMPROVED CONTAINER IMAGE DEPLOYMENT

(71) Applicant: Intel Corporation, Santa Clara, CA (US)

(72) Inventors: Ziye YANG, Shanghai (CN); Malini K. BHANDARU, San Jose, CA (US); Jiangyun ZHU, Shanghai (CN); Yu WANG, Shanghai (CN)

(21) Appl. No.: 17/853,800

(22) Filed: Jun. 29, 2022

(30) Foreign Application Priority Data
May 30, 2022 (CN) PCT/CN2022/095916

(51) Int. Cl. G06F 21/60; G06F 21/57; G06F 21/78; G06F 9/455

(52) U.S. Cl. CPC G06F 21/602; G06F 21/57; G06F 21/78; G06F 9/45558; G06F 2009/45587

(57) ABSTRACT

A method is described. The method includes sending a first request for portions of the container image. The method includes sending a second request for respective security keys for the portions of the container image. The method includes receiving the portions of the container image in encrypted form. The method includes receiving the respective security keys encrypted with a public key of an enclave of a trusted execution environment. The method includes decrypting the respective security keys with a private key of the enclave of the trusted execution environment. The method includes decrypting the encrypted portions of the container image with the decrypted respective keys.

### RELATED APPLICATION

This application claims the benefit of priority to Patent Cooperation Treaty (PCT) Application No. PCT/CN2022/095916 filed May 30, 2022. The entire content of that application is incorporated by reference.

### BACKGROUND

Centralized (e.g., cloud) or other data center application software runtime environments demand fast and secure execution of highly complex software processes. Developers of such application software programs are therefore constantly seeking ways to reduce the propagation and/or execution times of these processes, while, at the same time, reducing their exposure to unwanted observation or externally induced corruption.

### FIGURES

FIG. 1 shows a containerized application runtime environment;

FIG. 2 shows a traditional container image deployment process;

FIG. 3 shows an improved container image deployment process;

FIG. 4 shows an improved container image modification process;

FIG. 5 shows a system;

FIG. 6 shows a data center;

FIG. 7 shows a rack mount implementation.

### DETAILED DESCRIPTION

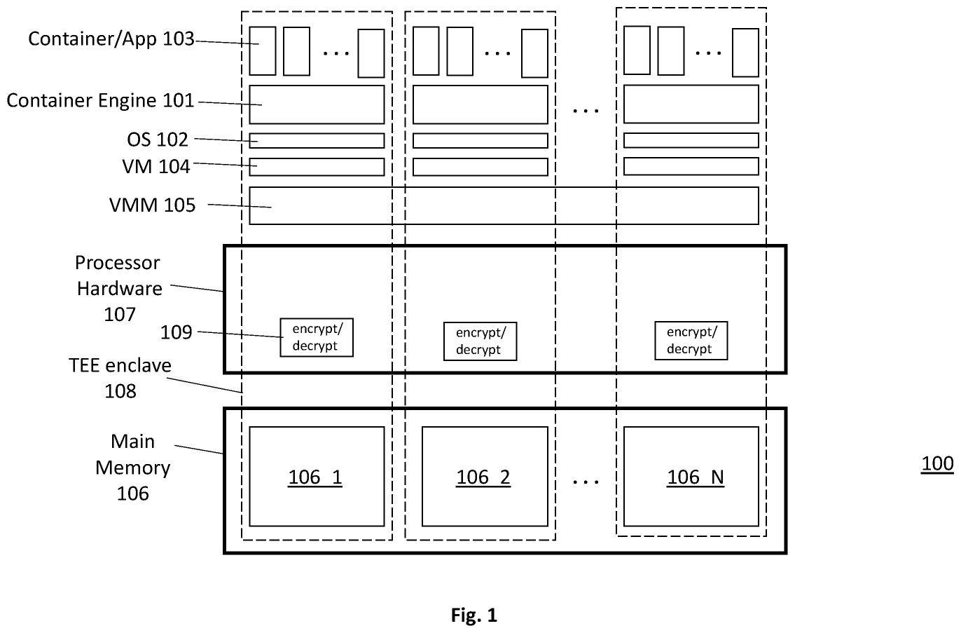

FIG. 1 depicts a traditional implementation of containerized software applications 100. As observed in FIG. 1, a container engine executes 101 on an operating system (OS) instance 102. The container engine 101 provides “OS level virtualization” for multiple containers 103 which execute on the container engine 101 (for ease of drawing only one container is labeled with a reference number). Here, each container 103 contains the program code, state and other information for a particular software application instance. As such, the operating environment for each instance of application software is contained within that software instance's respective container 103.

The operating system instance 102 executes on a virtual machine (VM) 104. A virtual machine monitor 105 (also referred to as a “hypervisor”) supports the execution of multiple VMs which, in turn, each support their own OS instance and corresponding container engine and containers.

The multiple virtual machines execute in a trusted execution environment (TEE). In a TEE, main memory 106 is divided into N different regions 106_1, 106_2, . . . 106_N and each VM is allocated to a particular one of the memory regions. For ease of illustration FIG. 1 shows one VM 104 being allocated per memory region 106_1. Although this is a possible configuration, other configurations allocate multiple VMs per memory region.

Ideally, a VM 104, and any software 102, 101, 103 that executes on the VM, can only access the region of memory 106_1 that the VM 104 has been allocated to. The specific region of memory 106_1 that a VM 104 and its software 101, 102, 103 has been allocated to, and the associated processor hardware 107 that implements the memory allocation during runtime, is referred to as an “enclave” 108 of the TEE.

Certain processor architectures that support TEE apply encryption/decryption 109 at the different memory regions 106_1, 106_2, . . . 106_N. Here, when a VM 104 or any of its software 101, 102, 103 issues a write to main memory 106, the processor hardware 109 encrypts the write data before the data is physically written to the VM's region of memory 106_1. Likewise, when the VM 104 or any of its software 101, 102, 103 issues a read from main memory 106, the encrypted data that is read from the VM's region of memory 106_1 is decrypted by the processor hardware 109 before being provided to the requesting software as the formal read response.

The architecture 100 of FIG. 1 provides security through isolation. Here, by restricting memory access of a VM 104 and its software 101, 102, 103 only to the particular region of memory 106_1 that the VM 104 has been allocated to, ideally, neither the VM 104 nor its software 101, 102, 103 can snoop the operation/data of other software that has been allocated to regions 106_2, . . . 106_N of memory other than the VM's region 106_1. Likewise, such other software cannot snoop the operations of the VM 104 or its software 101, 102, 103. Additionally, executing an application software program from within its own respective container 103 ideally isolates the operating environment of the application from other applications.

Besides isolation, containers also lend themselves to microservice architectures. Here, rather than being a “bird's nest” of custom written, inter-dependent processes, each software application 103 is a collection of previously written, fine grained software programs (microservices) that each perform a fine-grained task in respect to the larger overall application 103. With this approach, a software developer can readily develop a comprehensive, large scale application 103, e.g., by defining the application 103 as specific flows of specific sequences of microservices.

Importantly, completely different large scale applications can be readily developed from the same set of microservices. That is, for example, a first application developer can define a first application as a first set of flows having specific sequences of microservices, while a second application developer can define a second, different application as a second set of flows having different sequences of the same microservices.

In essence, the microservices correspond to low-level atomic functions/processes that are called out piecemeal in fine grained fashion by a higher level application to effect the functionality of the higher level application. An individual microservice is often, but not always, invoked over a network by some (e.g., cloud) service that leverages the microservice functionality. Thus, in many cases, the container 103 includes the program code that makes function calls (e.g., through an API) over a network to a remote location where the microservice is physically performed.

A “container image” is an archive of information used to deploy an instance of a particular application within a container 103. A container image typically includes, defines and/or describes program code (e.g., describing the application's flows and their microservice calls), libraries, files, configuration settings/options, meta data and/or other information that is specific to the application. To deploy an instance of an application, the container image for the application is fetched (e.g., over a network) and then “unpacked” by the container engine 101 that the container 103 will execute on. After the information in the container image is unpacked and processed, ideally, an instance of the application is ready for isolated execution on the container engine 104.

Container images are structured in layers to support an application's future developments/enhancements while, at the same time, preserving its legacy versions. Here, any changes made to a container image 103 are recorded at a next higher level in the container image (the previously existing lower levels are immutable and remain in the container image). If a user desires to deploy a version of application that includes its most recent changes, the user retrieves and unpacks the container image for the application having all levels including the highest level. By contrast, e.g., if a user desires to deploy a version of the application that existed just prior to its most recent change, the user retrieves and unpacks a version of the container having all levels except the highest level. More generally, individual layers of a container image can be viewed as different portions of the container image.

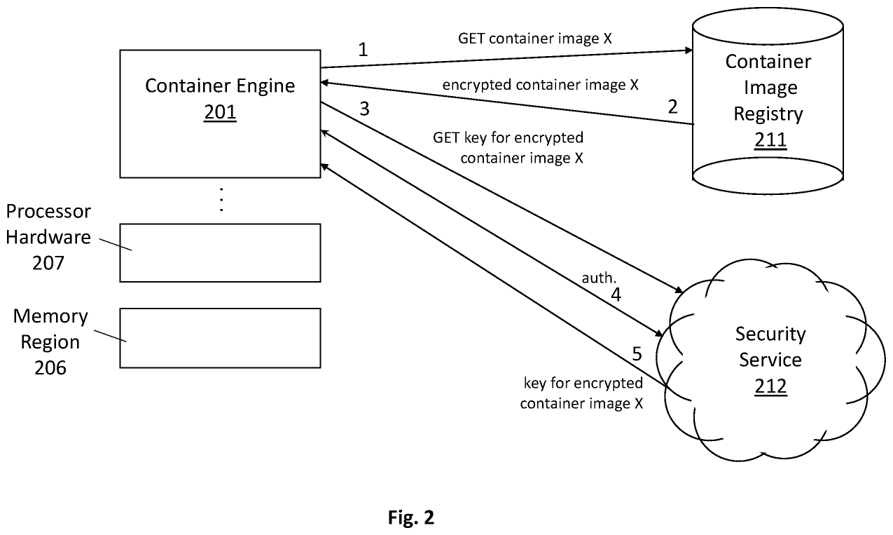

For security reasons container images can be encrypted. FIG. 2 depicts a standard process for retrieving an encrypted container image from a container image registry 211 and decrypting the encrypted container image using a security service 212 that provides security keys to authenticated users.

As observed in FIG. 2, the container engine 201 requests 1 a specific container image from the registry 211 (for ease of drawing the VMM, VM and OS are not depicted). In response, an encrypted form 2 of the requested container image is downloaded 2 to the container engine 201 from the registry 211. The container engine 201 then requests 3 a key to decrypt the container image from the security service 212. The security service 212 authenticates the container engine 201 and, upon successful authentication, sends the key 5 to the container engine 201. The container engine 201 then decrypts the container image with the key and proceeds to unpack the container image and instantiate the containerized application.

The above described approach includes various inefficiencies. Firstly, with respect to inefficiency, in the approach of FIG. 2 each container image has its own unique key, including assigning different keys to different versions of a same container image. As such, each time a new version of a container image is created (which as described above adds a new layer to the container image's prior version), a user must download the entire new version of the container image and decrypt it with a new key even if the user had previously successfully downloaded and decrypted the container image's prior version (all layers except the highest layer of the new version had already been received and decrypted). This corresponds to tremendous duplicity/overhead as the same lower layers of the container image are repeatedly received and decrypted.

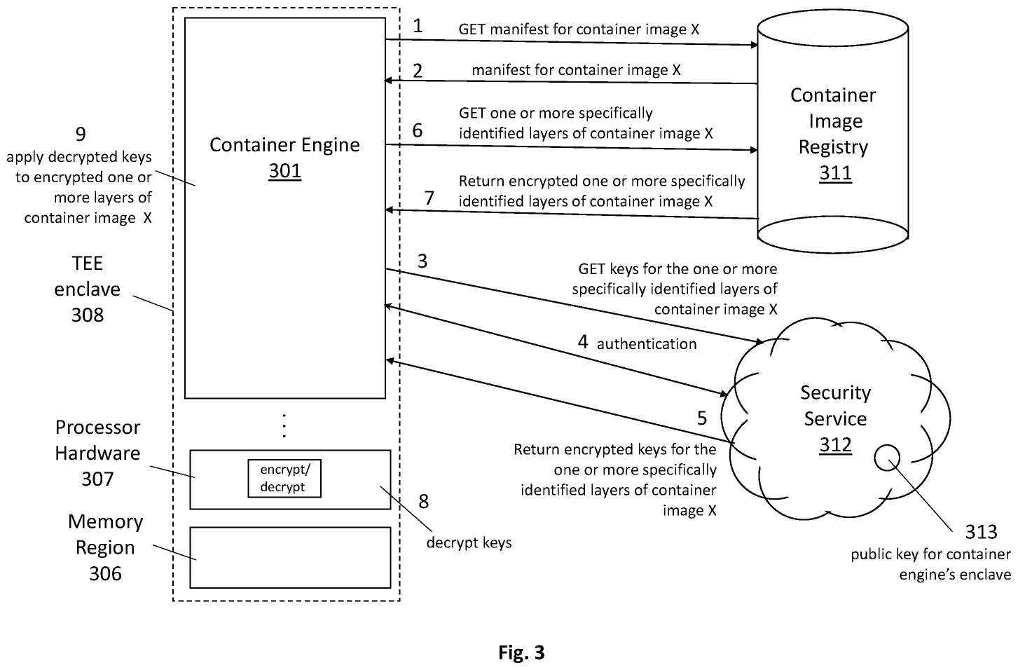

FIG. 3 pertains to an improved approach that uses the private/public key technology of a trusted execution environment to reduce duplicity and enhance security as compared to the above-described approach.

Notably, referring to FIG. 3, each enclave in a TEE includes its own private key. As such, a user can arrange to encrypt program code and/or data that is to be processed by an enclave with the enclave's public key. This allows for the secure sending of such program code and/or data outside the enclave. Once the encrypted program code and/or data is presented to the enclave, the enclave uses its internal private key to decrypt the code/data so that it can be processed in its true form within the enclave. More specifically, if code/data is to be sent to a particular enclave, the code/data is encrypted with the enclave's public key. Before the code/data is allowed to formally enter the enclave and be stored in the enclave's memory region, the processor hardware uses the enclave's private key to decrypt the code/data.

As such, in the approved approach, the security service 312 maintains the respective public key 313 for each enclave that is configured to receive encrypted container images from the container image registry 311 (for ease of drawing FIG. 3 only refers to one enclave). Additionally, as described in more detail below, each layer in the container image is assigned its own key thereby avoiding the decryption of a same contain image layer multiple times over (e.g., each time a new container image version is created).

Referring to FIG. 3, a container engine 301 operating within a TEE enclave 308 requests 1 a container image from a container image registry 311. The container image registry 311 responds to the request by sending 2 a manifest for the container image. The manifest describes, e.g., the different versions of the container image and the different layers associated with each version. The container engine 301 then identifies which layers of the container image it desires and builds a request for the keys for each of these layers.

For example, if the container engine 311 desires the latest version of the container image and has not previously downloaded any earlier version of the container image, the container engine 301 builds a request for all keys for all layers of the container image. By contrast, if the container engine 301 has previously downloaded all layers of the container image's immediately preceding version, the container engine 301 builds a key request for only the key of the container image's highest layer (the only layer of the container image that the container engine 301 has not previously received).

For the sake of example, the former circumstance is assumed (all layers of the container image are desired). As such, the container engine 301 builds a request that requests the respective keys for each of the container image's layers and sends 3 the request to the security service 312. In response, the security service 312 authenticates 4 the requesting enclave 308 (the enclave 308 has its own attestation information and functionality) and responds 5 to the request 3. The response 5 includes each of the requested keys together encrypted with the enclave's public key.

Meanwhile, e.g., concurrently with the key request being processed by the security service 312, the container engine requests 6 the download 7 of each layer of the container image from the container image registry 311. Each layer is encrypted with a unique key that is specific to the container image layer it is applied to (as described above, the container image 301 has concurrently requested 3 the corresponding per level keys for the per level encryption that each container image level is encrypted according to).

Here, in various embodiments, the session 3, 4, 5 between the container engine 301 and the security service 312 is secured through authentication 4 thereby allowing secure transfer 5 of the keys for the container image layers from the security service 312 to the container engine 301. In various embodiments, public key infrastructure (PKI) certificates are used to perform the authentication 4 (e.g., the container engine sends a PKI certificate (or causes a PKI certificate to be sent).

By contrast, the sessions 1, 2, 6, 7 between the container engine 301 and the container image registry 311 do not require authentication resulting in the different container image layers being encrypted with their corresponding keys (although, in various embodiments, authentication can be performed).

In a further embodiment, the download 7 of the encrypted container image layers is conditioned on successful authentication 4 of the requesting container engine 301 by the security service 312 (e.g., the container registry 311 confirms with the security service 312 that the requesting container engine 301 has been authenticated before downloading 7 the requested encrypted container image layer(s)). In even further embodiments, some container image layers may not be encrypted (e.g., their content is not deemed sensitive). Such unencrypted container image layers can be downloaded without the authentication precondition.

In an embodiment, separate and concurrent download sessions 7 are established for each encrypted layer which is downloaded to the container engine 301 which, in turn, enables the different layers to be downloaded 7 in a concurrent/parallel fashion (e.g., by transmission of each encrypted layer from a different transmission point into a network that separates the container image registry 311 and the container engine 301). Again, the downloads 7 can take place while the request 3 for the layers' respective keys is being processed 4, 5 by the security service 312.

After the per image layer keys 5 that are encrypted with the enclave's public key have been received from the security service 312 by the enclave 308, they are decrypted 8 with the enclave's private key. Each key is then used to decrypt its corresponding encrypted layer of the container image. When all of the layers have been decrypted, the container engine 301 has the full container image in decrypted form and can instantiate its corresponding application.

The above described example pertained to a situation in which the requesting container engine 301 desired the entire container image. In another situation the container engine 301 may desire, e.g., only the most recent layer of the container image. Such a situation could arise, for instance, if the container engine 301 has already downloaded and decrypted all previous, lower layers of the container image and only needs the most recently added, highest layer of the container image to possess all layers of the latest version of the container image.

In this case, upon receiving the manifest 2 for the container image, the container engine 301 builds a key list that identifies only the key for the highest layer of the container image. The key request 3 therefore only requests the single key for the highest container image layer from the security service 312. The single key is encrypted with the enclave's public key. Concurrently, the container engine 301 only downloads 7 the encrypted highest layer of the container image from the container image registry 311. Upon receipt 5 of the encrypted key from the security service 312, the enclave 308 decrypts the key with the enclave private key and uses the decrypted key to decrypt the highest layer of the container image. Upon the decryption of the highest layer of the container image, the container engine 301 possess all layers of the latest version of the container image.

As such, in the above two examples, the container engine 301 only requests the particular key(s)/layer(s) of the container image that it specifically needs/desires and that it has not already downloaded. As such, unlike the standard approach, the container engine 301 is not repeatedly downloading and decrypting a same container image layer, which, in turn, significantly streamlines container image download and deployment.

In various embodiments, all container engines that run within the same enclave 308 share the respective container image layers that they collectively download. Thus, if another container engine (not shown in FIG. 3) that runs within enclave 308 were to desire a container image (or set of container image layers) that container engine 301 had already downloaded, the sequence of FIG. 3 need not be performed (the enclave 308 already has the possession of the container image layers so they are reused for the other container engine).

Notably, in various instances a container engine 301 does not know if it has a most recent version of a particular container image that it has previously downloaded. Thus, the retrieval of the container image manifest 1, 2 can operate to inform the container engine 301 whether additional layers exist beyond the layers the container image 301 or enclave 308 already has. In certain circumstances, the container engine 301 may be triggered into requesting the container image manifest 1, 2 based on certain events such as receiving a request to deploy a container having a later version than the most recent version that the container engine 301 or enclave 308 has previously downloaded.

That is, for example, if the container engine 301 receives a request to deploy version 8.0 of a specific container image and recognizes that it or its enclave 308 has up to now only downloaded the layers for version 6.0 of the container image, the container engine 301 is triggered into requesting the manifest 1, 2 for the container image from the container registry 311 with the expectation that (two) additional versions and corresponding layers have been created for the container image since the engine's/enclave's most recent download of the container image.

In still other embodiments, a more restrictive approach is taken and container images used by different container engines are not shared including container engines that execute within a same enclave. In either approach, higher level (e.g., OS and/or application software) that executes on a same container image are allowed to share container image layers.

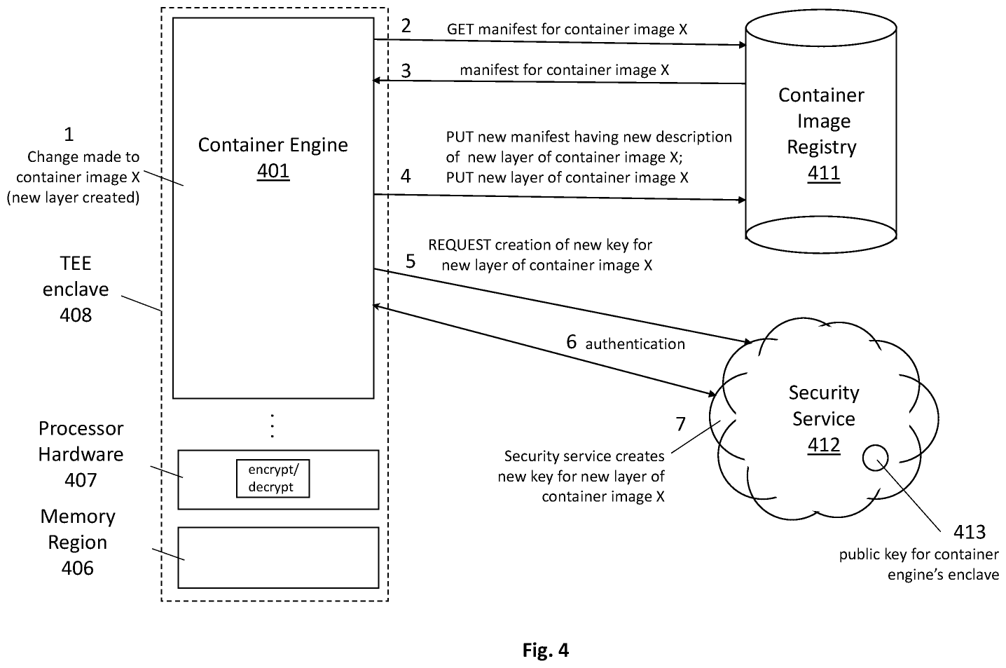

FIG. 4 shows a process for making a change to a container image within the framework discussed just above with respect to FIG. 3. As observed in FIG. 4, if an application that is executing upon the container engine 401 makes a change 1 to a container image (a new layer is created for the container image), the container engine 301 requests 2 the manifest for the container image, updates the manifest to include a description of the new layer and then causes the updated manifest and the new layer to be written 3 into the registry 411.

Concurrently, the container engine 401 requests 4 the security service 312 to create a new key for the container image's new layer. The security service 412 then creates 5 a key that is specific to the new layer.

In another approach, the security service 412 is requested 4 to a create key for the new layer before the new layer is sent from the container engine 401 to the registry. The security service 412 saves the key for the new layer locally. The container engine 401 then encrypts the new layer with the new key and sends it to the registry 411. Thus, the registry 411 stores the new layer in encrypted form for future download by other container engines or enclaves.

After the container image registry 411 has the updated manifest and has stored the new container image layer, and the security service 412 has created the new key(s) for the new layer, the framework is configured to fully execute the processes described above with respect to FIG. 3.

The encryption/decryption of a container image layer should not be understood to be limited to any particular type of key, but rather, is more generally directed to an approach where an encrypted layer of a container image is decrypted with a key for the layer that is requested and received.

The processes described above can be implemented with any publicly defined and/or publicly available information (e.g., industry standard) or software (e.g., open source software) directed to containers and/or container deployment. Examples include Docker and/or Kubernetes standards and/or software.

In the processes described just above the container image registry 311, 411 and the security service 312, 412 can each be implemented as any of a cloud service where a public network resides between the service and the container engine 301, 401, a service where only one or more private networks reside between the service and the container engine 301, 401, a local service that is implemented on the same chip hardware and/or same computer system as the container engine 301, 401, etc.

The processes described above with respect to FIGS. 3 and 4 do not necessarily need to be performed with a container engine, container image registry and/or security service as described above per se. Rather, any of the container engine, container image registry and security service can be replaced with one or more levels of software and/or one or more services designed to perform similar and/or corresponding functions. For example, the methods described above with respect to the container engine could be performed by an application within a container or other software related to the deployment of containerized applications. Likewise, the processes of the container image registry could be performed by one or more container image related service(s) and/or layer(s) of software. Finally, the processes of the security service could be performed by one or more security related service(s) and/or layer(s) of software.

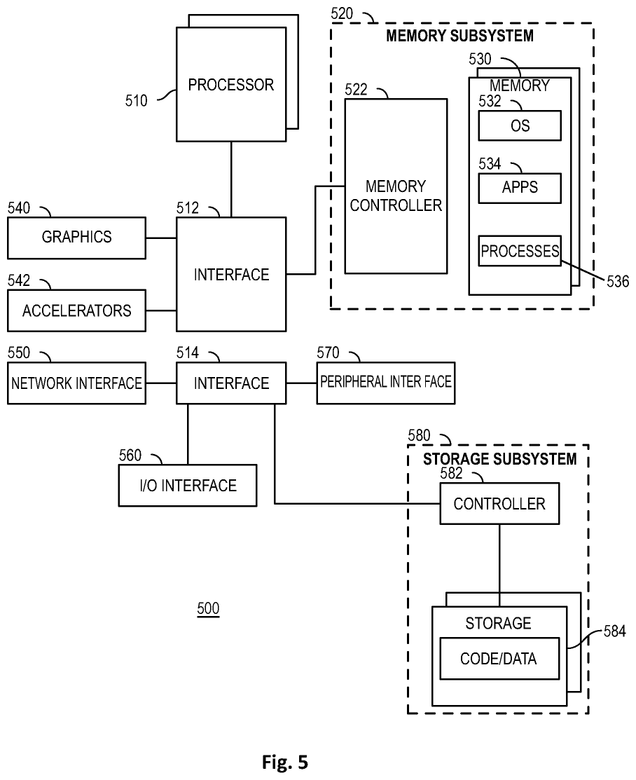

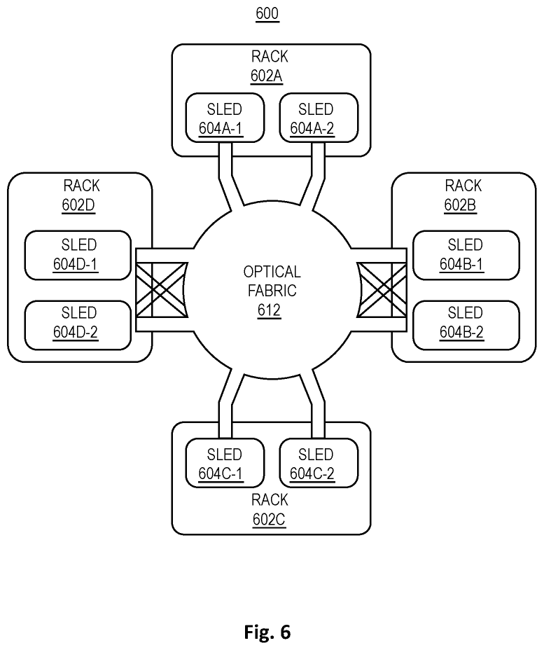

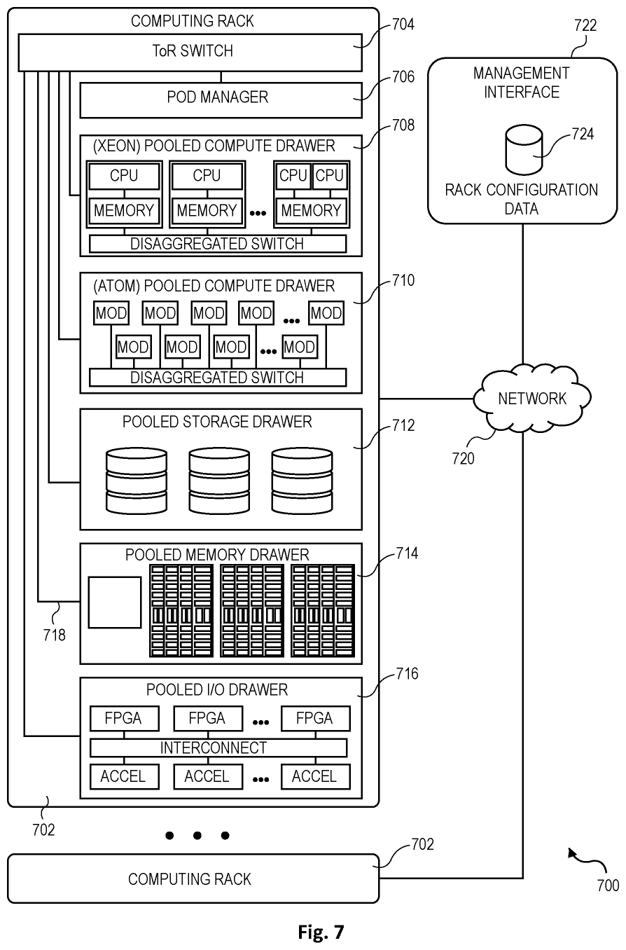

The following discussion concerning FIGS. 5, 6, and 7 are directed to systems, data centers and rack implementations, generally. FIG. 5 generally describes possible features of an electronic system that can perform the container image download processes described above. FIG. 6 describes possible features of a data center that can include such electronic systems. FIG. 7 describes possible features of a rack having one or more such electronic systems installed into it.

FIG. 5 depicts an example system. System 500 includes processor 510, which provides processing, operation management, and execution of instructions for system 500. Processor 510 can include any type of microprocessor, central processing unit (CPU), graphics processing unit (GPU), processing core, or other processing hardware to provide processing for system 500, or a combination of processors. Processor 510 controls the overall operation of system 500, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

Certain systems also perform networking functions (e.g., packet header processing functions such as, to name a few, next nodal hop lookup, priority/flow lookup with corresponding queue entry, etc.), as a side function, or, as a point of emphasis (e.g., a networking switch or router). Such systems can include one or more network processors to perform such networking functions (e.g., in a pipelined fashion or otherwise).

In one example, system 500 includes interface 512 coupled to processor 510, which can represent a higher speed interface or a high throughput interface for system components that needs higher bandwidth connections, such as memory subsystem 520 or graphics interface components 540, or accelerators 542. Interface 512 represents an interface circuit, which can be a standalone component or integrated onto a processor die. Where present, graphics interface 540 interfaces to graphics components for providing a visual display to a user of system 500. In one example, graphics interface 540 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 540 generates a display based on data stored in memory 530 or based on operations executed by processor 510 or both. In one example, graphics interface 540 generates a display based on data stored in memory 530 or based on operations executed by processor 510 or both.

Accelerators 542 can be a fixed function offload engine that can be accessed or used by a processor 510. For example, an accelerator among accelerators 542 can provide compression (DC) capability, cryptography services (cryptographic acceleration) such as public key encryption (PKE), cipher, hash/authentication capabilities, decryption, or other capabilities or services. In some embodiments, in addition or alternatively, an accelerator among accelerators 542 provides field select controller capabilities as described herein. In some cases, accelerators 542 can be integrated into a CPU socket (e.g., a connector to a motherboard or circuit board that includes a CPU and provides an electrical interface with the CPU). For example, accelerators 542 can include a single or multi-core processor, graphics processing unit, logical execution unit single or multi-level cache, functional units usable to independently execute programs or threads, application specific integrated circuits (ASICs), neural network processors (NNPs), “X” processing units (XPUs), programmable control logic circuitry, and programmable processing elements such as field programmable gate arrays (FPGAs). Accelerators 542 can provide multiple neural networks, processor cores, or graphics processing units can be made available for use by artificial intelligence (AI) or machine learning (ML) models. For example, the AI model can use or include any or a combination of a reinforcement learning scheme, Q-learning scheme, deep-Q learning, or Asynchronous Advantage Actor-Critic (A3C), convolutional neural network, recurrent convolutional neural network, or other AI or ML model. Multiple neural networks, processor cores, or graphics processing units can be made available for use by AI or ML models.

Memory subsystem 520 represents the main memory of system 500 and provides storage for code to be executed by processor 510, or data values to be used in executing a routine. Memory subsystem 520 can include one or more memory devices 530 such as read-only memory (ROM), flash memory, volatile memory, or a combination of such devices. Memory 530 stores and hosts, among other things, operating system (OS) 532 to provide a software platform for execution of instructions in system 500. Additionally, applications 534 can execute on the software platform of OS 532 from memory 530. Applications 534 represent programs that have their own operational logic to perform execution of one or more functions. Processes 536 represent agents or routines that provide auxiliary functions to OS 532 or one or more applications 534 or a combination. OS 532, applications 534, and processes 536 provide software functionality to provide functions for system 500. In one example, memory subsystem 520 includes memory controller 522, which is a memory controller to generate and issue commands to memory 530. It will be understood that memory controller 522 could be a physical part of processor 510 or a physical part of interface 512. For example, memory controller 522 can be an integrated memory controller, integrated onto a circuit with processor 510. In some examples, a system on chip (SOC or SoC) combines into one SoC package one or more of: processors, graphics, memory, memory controller, and Input/Output (I/O) control logic circuitry.

A volatile memory is memory whose state (and therefore the data stored in it) is indeterminate if power is interrupted to the device. Dynamic volatile memory requires refreshing the data stored in the device to maintain state. One example of dynamic volatile memory incudes DRAM (Dynamic Random Access Memory), or some variant such as Synchronous DRAM (SDRAM). A memory subsystem as described herein may be compatible with a number of memory technologies, such as DDR3 (Double Data Rate version 3, original release by JEDEC (Joint Electronic Device Engineering Council) on Jun. 27, 2007). DDR4 (DDR version 4, initial specification published in September 2012 by JEDEC), DDR4E (DDR version 4), LPDDR3 (Low Power DDR version3, JESD209-3B, August 2013 by JEDEC), LPDDR4) LPDDR version 4, JESD209-4, originally published by JEDEC in August 2014), WIO2 (Wide Input/Output version 2, JESD229-2 originally published by JEDEC in August 2014, HBM (High Bandwidth Memory), JESD235, originally published by JEDEC in October 2013, LPDDR5, HBM2 (HBM version 2), or others or combinations of memory technologies, and technologies based on derivatives or extensions of such specifications.

In various implementations, memory resources can be “pooled”. For example, the memory resources of memory modules installed on multiple cards, blades, systems, etc. (e.g., that are inserted into one or more racks) are made available as additional main memory capacity to CPUs and/or servers that need and/or request it. In such implementations, the primary purpose of the cards/blades/systems is to provide such additional main memory capacity. The cards/blades/systems are reachable to the CPUs/servers that use the memory resources through some kind of network infrastructure such as CXL, CAPI, etc.

The memory resources can also be tiered (different access times are attributed to different regions of memory), disaggregated (memory is a separate (e.g., rack pluggable) unit that is accessible to separate (e.g., rack pluggable) CPU units), and/or remote (e.g., memory is accessible over a network).

While not specifically illustrated, it will be understood that system 500 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect express (PCIe) bus, a HyperTransport or industry standard architecture (ISA) bus, a small computer system interface (SCSI) bus, Remote Direct Memory Access (RDMA), Internet Small Computer Systems Interface (iSCSI), NVM express (NVMe), Coherent Accelerator Interface (CXL), Coherent Accelerator Processor Interface (CAPI), Cache Coherent Interconnect for Accelerators (CCIX), Open Coherent Accelerator Processor (Open CAPI) or other specification developed by the Gen-z consortium, a universal serial bus (USB), or an Institute of Electrical and Electronics Engineers (IEEE) standard 1394 bus.

In one example, system 500 includes interface 514, which can be coupled to interface 512. In one example, interface 514 represents an interface circuit, which can include standalone components and integrated circuitry. In one example, multiple user interface components or peripheral components, or both, couple to interface 514. Network interface 550 provides system 500 the ability to communicate with remote devices (e.g., servers or other computing devices) over one or more networks. Network interface 550 can include an Ethernet adapter, wireless interconnection components, cellular network interconnection components, USB (universal serial bus), or other wired or wireless standards-based or proprietary interfaces. Network interface 550 can transmit data to a remote device, which can include sending data stored in memory. Network interface 550 can receive data from a remote device, which can include storing received data into memory. Various embodiments can be used in connection with network interface 550, processor 510, and memory subsystem 520.

In one example, system 500 includes one or more input/output (I/O) interface(s) 560. I/O interface 560 can include one or more interface components through which a user interacts with system 500 (e.g., audio, alphanumeric, tactile/touch, or other interfacing). Peripheral interface 570 can include any hardware interface not specifically mentioned above. Peripherals refer generally to devices that connect dependently to system 500. A dependent connection is one where system 500 provides the software platform or hardware platform or both on which operation executes, and with which a user interacts.

In one example, system 500 includes storage subsystem 580 to store data in a nonvolatile manner. In one example, in certain system implementations, at least certain components of storage 580 can overlap with components of memory subsystem 520. Storage subsystem 580 includes storage device(s) 584, which can be or include any conventional medium for storing large amounts of data in a nonvolatile manner, such as one or more magnetic, solid state, or optical based disks, or a combination. Storage 584 holds code or instructions and data in a persistent state (e.g., the value is retained despite interruption of power to system 500). Storage 584 can be generically considered to be a “memory,” although memory 530 is typically the executing or operating memory to provide instructions to processor 510. Whereas storage 584 is nonvolatile, memory 530 can include volatile memory (e.g., the value or state of the data is indeterminate if power is interrupted to system 500). In one example, storage subsystem 580 includes controller 582 to interface with storage 584. In one example controller 582 is a physical part of interface 514 or processor 510 or can include circuits in both processor 510 and interface 514.

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), NVM devices that use chalcogenide phase change material (for example, chalcogenide glass), resistive memory including metal oxide base, oxygen vacancy base, and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

Such non-volatile memory devices can be placed on a DIMM and cooled according to the teachings above.

A power source (not depicted) provides power to the components of system 500. More specifically, power source typically interfaces to one or multiple power supplies in system 500 to provide power to the components of system 500. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 500 can be implemented as a disaggregated computing system. For example, the system 500 can be implemented with interconnected compute sleds of processors, memories, storages, network interfaces, and other components. High speed interconnects can be used such as PCIe, Ethernet, or optical interconnects (or a combination thereof). For example, the sleds can be designed according to any specifications promulgated by the Open Compute Project (OCP) or other disaggregated computing effort, which strives to modularize main architectural computer components into rack-pluggable components (e.g., a rack pluggable processing component, a rack pluggable memory component, a rack pluggable storage component, a rack pluggable accelerator component, etc.).

Although a computer is largely described by the above discussion of FIG. 5, other types of systems to which the above described invention can be applied and are also partially or wholly described by FIG. 5 are communication systems such as routers, switches, and base stations.

FIG. 6 depicts an example of a data center. Various embodiments can be used in or with the data center of FIG. 6. As shown in FIG. 6, data center 600 may include an optical fabric 612. Optical fabric 612 may generally include a combination of optical signaling media (such as optical cabling) and optical switching infrastructure via which any particular sled in data center 600 can send signals to (and receive signals from) the other sleds in data center 600. However, optical, wireless, and/or electrical signals can be transmitted using fabric 612. The signaling connectivity that optical fabric 612 provides to any given sled may include connectivity both to other sleds in a same rack and sleds in other racks.

Data center 600 includes four racks 602A to 602D and racks 602A to 602D house respective pairs of sleds 604A-1 and 604A-2, 604B-1 and 604B-2, 604C-1 and 604C-2, and 604D-1 and 604D-2. Thus, in this example, data center 600 includes a total of eight sleds. Optical fabric 612 can provide sled signaling connectivity with one or more of the seven other sleds. For example, via optical fabric 612, sled 604A-1 in rack 602A may possess signaling connectivity with sled 604A-2 in rack 602A, as well as the six other sleds 604B-1, 604B-2, 604C-1, 604C-2, 604D-1, and 604D-2 that are distributed among the other racks 602B, 602C, and 602D of data center 600. The embodiments are not limited to this example. For example, fabric 612 can provide optical and/or electrical signaling.

FIG. 7 depicts an environment 700 that includes multiple computing racks 702, each including a Top of Rack (ToR) switch 704, a pod manager 706, and a plurality of pooled system drawers. Generally, the pooled system drawers may include pooled compute drawers and pooled storage drawers to, e.g., effect a disaggregated computing system. Optionally, the pooled system drawers may also include pooled memory drawers and pooled Input/Output (I/O) drawers. In the illustrated embodiment the pooled system drawers include an INTEL® XEON® pooled computer drawer 708, and INTEL® ATOM™ pooled compute drawer 710, a pooled storage drawer 712, a pooled memory drawer 714, and a pooled I/O drawer 716. Each of the pooled system drawers is connected to ToR switch 704 via a high-speed link 718, such as a 40 Gigabit/second (Gb/s) or 100 Gb/s Ethernet link or an 100+Gb/s Silicon Photonics (SiPh) optical link. In one embodiment high-speed link 718 comprises an 600 Gb/s SiPh optical link.

Again, the drawers can be designed according to any specifications promulgated by the Open Compute Project (OCP) or other disaggregated computing effort, which strives to modularize main architectural computer components into rack-pluggable components (e.g., a rack pluggable processing component, a rack pluggable memory component, a rack pluggable storage component, a rack pluggable accelerator component, etc.).

Multiple of the computing racks 700 may be interconnected via their ToR switches 704 (e.g., to a pod-level switch or data center switch), as illustrated by connections to a network 720. In some embodiments, groups of computing racks 702 are managed as separate pods via pod manager(s) 706. In one embodiment, a single pod manager is used to manage all of the racks in the pod. Alternatively, distributed pod managers may be used for pod management operations. RSD environment 700 further includes a management interface 722 that is used to manage various aspects of the RSD environment. This includes managing rack configuration, with corresponding parameters stored as rack configuration data 724.

Any of the systems, data centers or racks discussed above, apart from being integrated in a typical data center, can also be implemented in other environments such as within a bay station, or other micro-data center, e.g., at the edge of a network.

Embodiments herein may be implemented in various types of computing, smart phones, tablets, personal computers, and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds, and other design or performance constraints, as desired for a given implementation.

Some examples may be implemented using or as an article of manufacture or at least one computer-readable medium. A computer-readable medium may include a non-transitory storage medium to store program code. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the program code implements various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled, and/or interpreted programming language.

To the extent any of the teachings above can be embodied in a semiconductor chip, a description of a circuit design of the semiconductor chip for eventual targeting toward a semiconductor manufacturing process can take the form of various formats such as a (e.g., VHDL or Verilog) register transfer level (RTL) circuit description, a gate level circuit description, a transistor level circuit description or mask description or various combinations thereof. Such circuit descriptions, sometimes referred to as “IP Cores”, are commonly embodied on one or more computer readable storage media (such as one or more CD-ROMs or other type of storage technology) and provided to and/or otherwise processed by and/or for a circuit design synthesis tool and/or mask generation tool. Such circuit descriptions may also be embedded with program code to be processed by a computer that implements the circuit design synthesis tool and/or mask generation tool.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software, and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences may also be performed according to alternative embodiments. Furthermore, additional sequences may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

1. A method, comprising:
sending a first request for portions of a container image;
sending a second request for respective security keys for the portions of the container image;
receiving the portions of the container image in encrypted form;
receiving the respective security keys encrypted with a public key of an enclave of a trusted execution environment;
decrypting the respective security keys with a private key of the enclave of the trusted execution environment; and,
decrypting the encrypted portions of the container image with the decrypted respective keys.

2. The method of claim 1 wherein the method is performed by a container engine.

3. The method of claim 2 wherein the container engine executes within the enclave.

4. The method of claim 1 wherein the method further comprises performing the following before the sending of the first and second requests:
sending a third request for a manifest of a container image; and,
identifying from the manifest the portions of the container image.

5. The method of claim 1 wherein the method further comprises sharing the encrypted portions of the container image amongst multiple container engines that execute within the enclave.

6. The method of claim 1 further comprising:
making a change to the container image that adds a new layer to the container image;
updating a manifest for the container image with information describing the new layer;
sending the updated manifest and the new layer to a container image registry; and,
notifying a security service of the new layer to cause the security service to create a respective key for the new layer.

7. The method of claim 6 wherein at least one of the container image registry and the security service is a cloud service.

8. A data center, comprising:
a plurality of computing systems communicatively coupled through networks, wherein, a computing system of the computing systems comprises a) and b) below:
a) processor hardware that divides main memory into different segments, the different segments corresponding to different trusted execution environment enclaves;
b) container engine program code stored in one of the segments, the container image program code to cause a container engine to execute on the operating system and perform the following method:
send a first request for portions of a container image;
send a second request for respective security keys for the portions of the container image;
receive the portions of the container image in encrypted form;
receive the respective security keys encrypted with a public key of an enclave of a trusted execution environment;
decrypt the respective security keys with a private key of the enclave of the trusted execution environment; and,
decrypt the encrypted portions of the container image with the decrypted respective keys.

9. The data center of claim 8 wherein the container engine executes within the enclave.

10. The data center of claim 8 wherein the method further comprises performing the following before the sending of the first and second requests:
sending a third request for a manifest of a container image; and,
identifying from the manifest the portions of the container image.

11. The data center of claim 8 wherein the method further comprises sharing the encrypted portions of the container image amongst multiple container engines that execute within the enclave.

12. The data center of claim 8 wherein the method further comprises:
making a change to the container image that adds a new layer to the container image;
updating a manifest for the container image with information describing the new layer;
sending the updated manifest and the new layer to a container image registry; and,
notifying a security service of the new layer to cause the security service to create a respective key for the new layer.

13. The data center of claim 12 wherein at least one of the container image registry and the security service is a cloud service.

14. A machine readable storage medium containing program code that when processed by a computer system causes the computer system to perform a method, comprising:
sending a first request for portions of a container image;
sending a second request for respective security keys for the portions of the container image;
receiving the portions of the container image in encrypted form;
receiving the respective security keys encrypted with a public key of an enclave of a trusted execution environment;
decrypting the respective security keys with a private key of the enclave of the trusted execution environment; and,
decrypting the encrypted portions of the container image with the decrypted respective keys.

15. The machine readable storage medium of claim 14 wherein the method is performed by a container engine.

16. The machine readable storage medium of claim 15 wherein the container engine executes within the enclave.

17. The machine readable storage medium of claim 14 wherein the method further comprises performing the following before the sending of the first and second requests:
sending a third request for a manifest of a container image; and,
identifying from the manifest the portions of the container image.

18. The machine readable storage medium of claim 14 wherein the method further comprises sharing the encrypted portions of the container image amongst multiple container engines that execute within the enclave.

19. The machine readable storage medium of claim 14 further comprising:
making a change to the container image that adds a new layer to the container image;
updating a manifest for the container image with information describing the new layer;
sending the updated manifest and the new layer to a container image registry; and,
notifying a security service of the new layer to cause the security service to create a respective key for the new layer.

20. The machine readable storage medium of claim 19 wherein at least one of the container image registry and the security service is a cloud service.
